(19) United States
(12) Patent Application Publication
(10) Pub. No.: US 2019/0161627 A1
(43) Pub. Date: May 30, 2019

(54) NOVEL ANTIFOULING TECHNOLOGY BY RAFT POLYMERIZATION

(71) Applicant: University of Florida Research Foundation, Inc., Gainesville, FL (US)

(72) Inventors: Anthony B. BRENNAN, Gainesville, FL (US); Cary A. KULIASHA, Gainesville, FL (US)

(73) Assignee: University of Florida Research Foundation, Inc., Gainesville, FL (US)

(21) Appl. No.: 16/302,174

(22) PCT Filed: May 22, 2017
(86) PCT No.: PCT/IB2017/053007

§ 371 Date: Nov. 16, 2018

Related U.S. Application Data
(60) Provisional application No. 62/339,597, filed on May 20, 2016.

(51) Int. Cl. C09D 5/16

(52) U.S. Cl. CPC C09D 5/1681; C08F 291/185; C09D 5/1625; C09D 5/1668

(57) ABSTRACT

Directed bioadhesion coatings, methods of forming directed bioadhesion coatings, and methods of directing bioadhesion are provided. In particular, methods of forming directed bioadhesion coatings include providing a substrate having a graft monomer layer on a surface thereof, selectively removing discrete portions of the graft monomer layer to expose the substrate surface, polymerizing any remaining portions of the graft monomer layer via reversible addition-fragmentation chain-transfer (RAFT) polymerization with a RAFT chain transfer agent to form a plurality of graft polymers, and simultaneously with polymerizing the remaining graft monomer layer, grafting the plurality of graft polymers to the substrate to form a chemical pattern on the substrate.

### STATEMENT REGARDING FEDERALLY SPONSORED RESEARCH OR DEVELOPMENT

This invention was made with government support under N00014-13-1-0443 awarded by Navy/Office of Naval Research. The government has certain rights in the invention.

### TECHNICAL FIELD

The presently-disclosed invention relates generally to directed bioadhesion coatings and methods of forming and using the same, and more particularly to methods of forming directed bioadhesion coatings including chemical patterns to direct bioadhesion.

### BACKGROUND

Biofouling is the result of marine organisms settling, attaching, and growing on submerged marine surfaces. The biofouling process is initiated within minutes of a surface being submerged in a marine environment by the absorption of dissolved organic materials which result in the formation of a conditioning film. Once the conditioning film is deposited, bacteria (e.g. unicellular algae) colonize the surface within hours of submersion. The resulting biofilm produced from the colonization of the bacteria is referred to as microfouling or slime and can reach thicknesses on the order of 500 μm.

Biofouling is estimated to cost the US Navy alone over $1 billion per year by increasing the hydrodynamic drag of naval vessels. This in turn decreases the range, speed, and maneuverability of naval vessels and increases the fuel consumption by up to 30-40%. Thus, biofouling weakens the national defense. Moreover, biofouling is also a major economical burden on commercial shipping, recreational craft, as well as civil structures, bridges, and power generating facilities.

Any substrate in regular contact with water is likely to become fouled. No surface has been found that is completely resistant to fouling. Due to the vast variety of marine organisms that form biofilms, the development of a single surface coating with fixed surface properties for the prevention biofilm formation for all relevant marine organisms is a difficult if not impossible task.

Poly(dimethyl siloxane) elastomer (PDMSe) is a ubiquitous polymeric material that is utilized in microfluidics, electrophoretic separation, and medical devices due to its optical transparency, oxygen permeability, and low cost, in addition to its relative biocompatibility and chemical stability in biological environments. PDMSe is easy to physically emboss with a variety of microtopographies for soft lithography, biofouling research, and microfluidic designs, and it is commonly used as a fouling release standard due to its low modulus combined with low surface free energy (SFE), i.e. hydrophobicity, which limits the bioadhesion of some organisms to its surface. However, there are several drawbacks that can limit its applicability in these areas such as its high susceptibility to non-specific protein adhesion, fouling by many marine organisms, such as diatoms, and wetting/adhesion difficulties in microfluidics.

Accordingly, there still exists a need for directed bioadhesion coatings having tailored surface properties that prevent protein adhesion, biofouling, and other problems with wetting/adhesion.

### BRIEF SUMMARY OF THE INVENTION

One or more embodiments of the invention may address one or more of the aforementioned problems. In one aspect, methods of forming a directed bioadhesion coating are provided. In accordance with certain embodiments of the invention, the method includes providing a substrate having a graft monomer layer on a surface thereof, selectively removing discrete portions of the graft monomer layer to expose the substrate surface, polymerizing any remaining portions of the graft monomer layer via reversible addition-fragmentation chain-transfer (RAFT) polymerization with a RAFT chain transfer agent to form a plurality of graft polymers, an simultaneously with polymerizing the remaining graft monomer layer, grafting the plurality of graft polymers to the substrate to form a chemical pattern on the substrate.

In another aspect, directed bioadhesion coatings are provided. In accordance with certain embodiments of the invention, the directed bioadhesion coating includes a substrate and a plurality of graft polymers grafted on the substrate such that the plurality of graft polymers define a chemical pattern on the substrate.

In yet another aspect, methods of directing bioadhesion on a base surface are provided. In accordance with certain embodiments of the invention, the method includes providing a directed bioadhesion coating on the base surface. The directed bioadhesion coating includes a substrate and a plurality of graft polymers grafted on the substrate such that the plurality of graft polymers define a chemical pattern on the substrate.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B are schematic diagrams of a directed bioadhesion coating in accordance with certain embodiments of the invention;

FIG. 2 is a block diagram illustrating a method of forming a directed bioadhesion coating in accordance with certain embodiments of the invention;

FIG. 3 illustrates a method of forming a directed bioadhesion coating in accordance with certain embodiments of the invention;

FIG. 4 is a collection of atomic-force microscopy images of a chemical pattern in accordance with certain embodiments of the invention;

FIG. 5 illustrates the effect of UV polymerization time on poly(acrylamide)-g-PDMSe in accordance with certain embodiments of the invention;

FIG. 6 illustrates the effect of UV polymerization time on the chemical pattern in accordance with certain embodiments of the invention;

FIGS. 7A-7D are graphs illustrating RAFT solution polymerization results in accordance with certain embodiments of the invention;

FIG. 8 is ATR-FTIR spectra of synthesized polymers in accordance with certain embodiments of the invention;

FIG. 9 illustrates U. linza attachment density on PDMSe surfaces in accordance with certain embodiments of the invention;

FIG. 10 illustrates leachate toxicity comparison for test surfaces compared to positive and negative growth controls in accordance with certain embodiments of the invention;

FIG. 11 illustrates biomass of N. incerta following various conditions on grafted and non-grafted surfaces in accordance with certain embodiments of the invention;

FIG. 12 illustrates biomass of C. lytica following various conditions on grafted and non-grafted surfaces in accordance with certain embodiments of the invention; and

FIG. 13 illustrates algal spore attachment density of U. linza on poly(acrylamide) patterned PDMSe substrates in accordance with certain embodiments of the invention.

### DETAILED DESCRIPTION OF THE INVENTION

The invention now will be described more fully hereinafter with reference to the accompanying drawings, in which some, but not all embodiments of the inventions are shown. Indeed, this inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

The invention includes, according to certain embodiments, directed bioadhesion coatings and methods of forming and using the same. In particular, embodiments of the invention are directed to methods of forming directed bioadhesion coatings including chemical patterns to direct bioadhesion. In this regard, the resulting directed bioadhesion coatings have tailored surface properties that prevent protein adhesion, biofouling, and other problems with wetting/adhesion.

Although the coatings and methods discussed herein are frequently described as being anti-biofouling coatings, one of ordinary skill in the art would understand that preventing biofouling is only one such application of the coatings. In particular, one of ordinary skill in the art would understand that these coatings may be used to direct bioadhesion on a surface, for example, by improving anti-biofouling properties or cell adhesion and/or intentional biofouling (e.g., in tissue engineering applications). In this regard, although the term “anti-biofouling” is used herein, one of ordinary skill in the art would understand that the term “anti-biofouling” may be substituted with, by way of example only, the terms “directed bioadhesion”, “adhesion-improving”, “bioadhesion-affecting”, and/or the like depending on the target application of the coatings.

### I. Definitions

For the purposes of the present application, the following terms shall have the following meanings:

The terms “substantial” or “substantially” may encompass the whole amount as specified, according to certain embodiments of the invention, or largely but not the whole amount specified according to other embodiments of the invention.

The term “layer”, as used herein, may comprise a generally recognizable combination of material types and/or functions existing in the X-Y plane.

The term “substrate”, as used herein, may generally refer to a substance, surface, or layer on which a process, such as the processes in accordance with certain embodiments of the invention described herein, occurs.

The terms “polymer” or “polymeric”, as used interchangeably herein, may comprise homopolymers, copolymers, such as, for example, block, graft, random, and alternating copolymers, terpolymers, etc., and blends and modifications thereof. Furthermore, unless otherwise specifically limited, the term “polymer” or “polymeric” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material. The term “polymer” or “polymeric” shall also include polymers made from various catalyst systems including, without limitation, the Ziegler-Natta catalyst system and the metallocene/single-site catalyst system.

The terms “monomer” or “monomeric”, as used herein, may generally refer to any molecule that, as a unit, binds chemically or supramolecularly to other molecules to form a polymer.

The terms “graft” or “grafting”, as used herein, may generally refer to the addition of polymer chains onto a surface. In particular, in the context of certain embodiments of the invention, the terms “graft” or “grafting” may refer to a “grafting onto” mechanism in which a polymer chain adsorbs onto a surface out of solution. The definition of “graft” or “grafting”, however, is not limited only to the “grafting onto” mechanism but may include any suitable grafting mechanism as understood by one of ordinary skill in the art.

The term “biocidal agent”, as used herein, may generally refer to any chemical substance or microorganism intended to destroy, deter, render harmless, or exert a controlling effect on any harmful organism by chemical or biological means. In this regard, the term “biocidal agent” may comprise any of a number of pesticides and/or antimicrobials, including but not limited to fungicides, herbicides, algicides, molluscicides, germicides, antibiotics, antibacterials, antivirals, antifungals, antiprotozoals, antiparasites, and/or the like.

### II. Directed Bioadhesion Coatings and Methods of Forming the Same

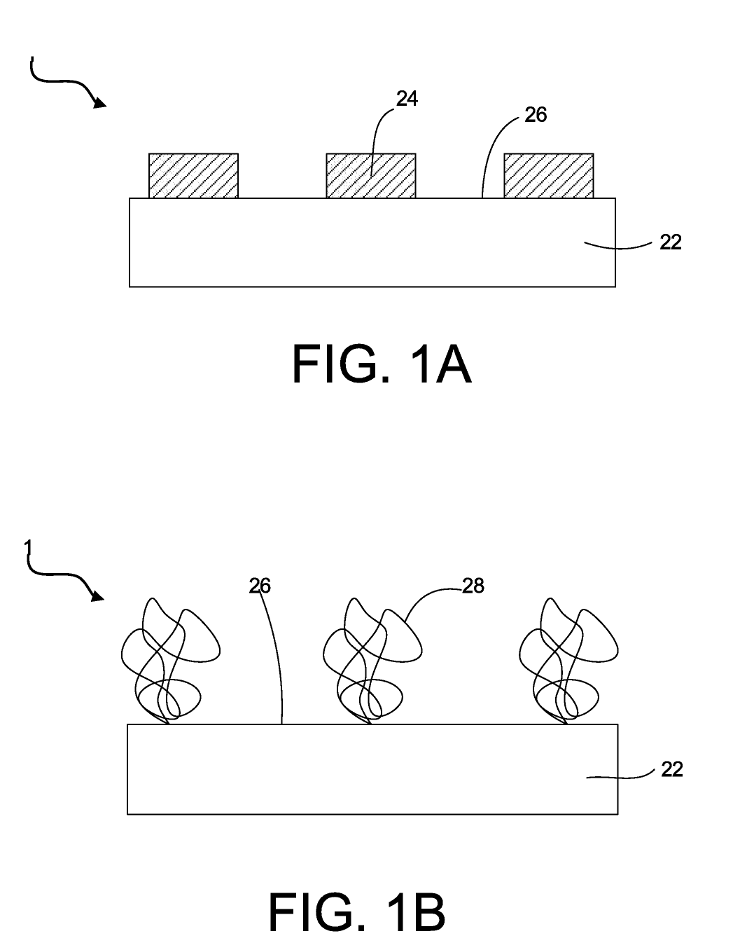

Certain embodiments according to the invention provide methods of forming directed bioadhesion coatings. In accordance with certain embodiments, the method includes providing a substrate having a graft monomer layer on a surface thereof, selectively removing discrete portions of the graft monomer layer to expose the substrate surface, polymerizing any remaining portions of the graft monomer layer via reversible addition-fragmentation chain-transfer (RAFT) polymerization with a RAFT chain transfer agent to form a plurality of graft polymers, and simultaneously with polymerizing the remaining graft monomer layer, grafting the plurality of graft polymers to the substrate to form a chemical pattern on the substrate. As shown in FIG. 1A, for example, the anti-biofouling coating 1 (prior to RAFT polymerization) includes a substrate 22 having a graft monomer layer 24 with discrete portions removed positioned on a surface 26 of the substrate 22. FIG. 1B, however, illustrates the anti-biofouling coating 1 after RAFT polymerization and grafting such that a plurality of graft polymers 28 are positioned on a surface 26 of the substrate 22.

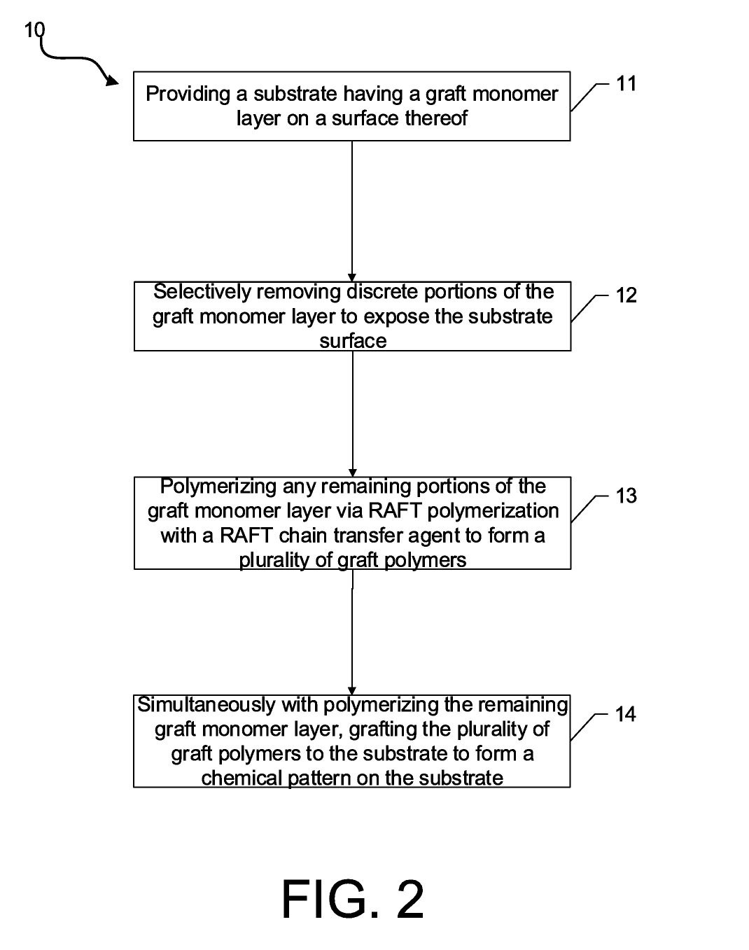

FIG. 2, for example, is a block diagram illustrating a method 10 of forming an anti-biofouling coating in accordance with certain embodiments of the invention. As shown in FIG. 2, the method 10 includes providing a substrate having a graft monomer layer on a surface thereof at operation 11, selectively removing discrete portions of the graft monomer layer to expose the substrate surface at operation 12, polymerizing any remaining portions of the graft monomer layer via reversible addition-fragmentation chain-transfer (RAFT) polymerization with a RAFT chain transfer agent to form a plurality of graft polymers at operation 13, and simultaneously with polymerizing the remaining graft monomer layer, grafting the plurality of graft polymers to the substrate to form a chemical pattern on the substrate at operation 14. In this regard, the resulting anti-biofouling coating includes a substrate and a plurality of graft polymers grafted on the substrate such that the plurality of graft polymers define a chemical pattern on the substrate.

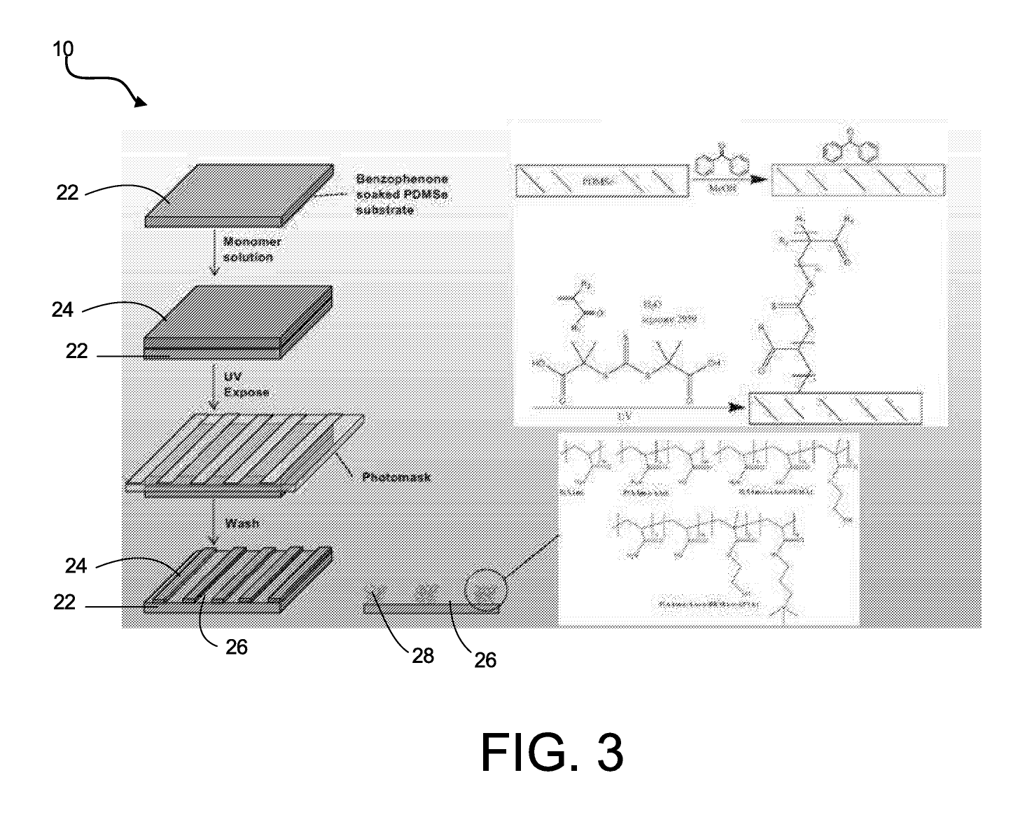

FIG. 3, for instance, illustrates a method 10 of forming an anti-biofouling coating in accordance with certain embodiments of the invention. As shown in FIG. 3, a graft monomer layer 24 (e.g., a monomer solution) may be positioned on a surface of a substrate 22 (e.g., a benzophenone-soaked PDMSe substrate). As illustrated in FIG. 3 and as further discussed herein, distinct portions of the graft monomer layer 24 may be removed by, for example, exposing the monomer layer 24 to UV light through a photomask, to expose the substrate 22. The remaining portions of the graft monomer layer 24 may then be polymerized via RAFT polymerization to form a plurality of graft polymers 26 that are grafted to the substrate 22 to form a chemical pattern. In this regard, the combination of selectively removing portions of the graft monomer layer 24 and grafting polymers 26 to the substrate 22 forms the chemical pattern on the substrate 22.

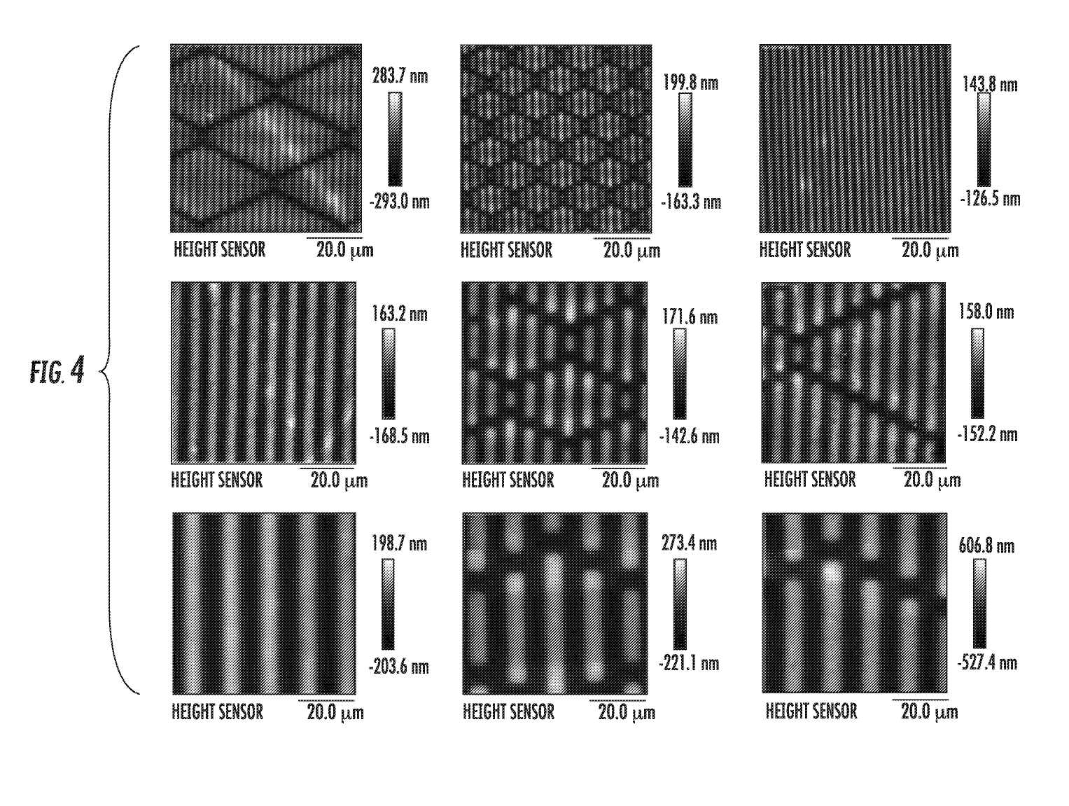

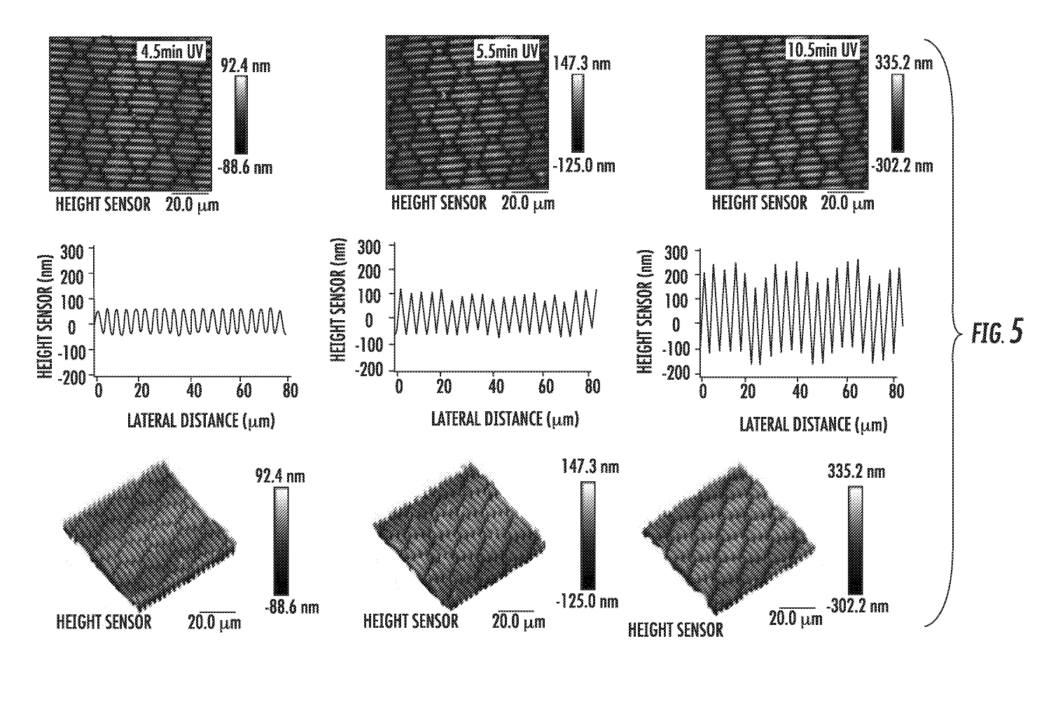

FIG. 4, for example, is a collection of atomic-force microscopy images of different chemical patterns in accordance with certain embodiments of the invention. As shown in FIG. 4, the chemical pattern may include a substantially diamond-like pattern. Although a diamond pattern is shown in FIG. 4, the chemical pattern is not limited to a diamond-like pattern and may be any chemical pattern suitable for preventing protein adhesion, biofouling, and other problems with wetting/adhesion as understood by one of ordinary skill in the art. In particular, additional patterns may include, but are not limited to, at least one of channels, pillars, pillars and triangles, squares, variations of the Sharklet® geometry as shown in, for example, U.S. Pat. Nos. 7,117,807, 7,143,709, 7,650,848, 8,997,672, and 9,016,221 and U.S. application Ser. No. 12/616,915 incorporated by reference herein, or any combination thereof. For example, modifications to the Sharklet® geometry may include, but are not limited to, variations to the feature size/spacing, the number of unique features, the angle between adjacent features, pattern tortuosity, or any combination thereof. In some embodiments, for instance, the chemical pattern height may be from about 0.001 μm to about 100 μm. In further embodiments, for example, the lateral feature size/spacing may be from about 1 μm to about 10,000 μm.

In accordance with certain embodiments, for instance, the substrate may comprise at least one of a polypropylene, a polyethylene, polyethylene terephthalate, a silicone rubber, polyvinyl chloride, a polyamide, or any combination thereof. In this regard, the substrate may include one or more of these materials. In some embodiments, for example, the substrate may comprise a silicone rubber. In further embodiments, for instance, the silicone rubber may comprise a poly(dimethylsiloxane) elastomer (PDMSe). In other embodiments, for example, the substrate may comprise a polyamide. In such embodiments, for instance, the polyamide may comprise at least one of a variety of nylons.

In accordance with certain embodiments, for example, the graft monomer layer may comprise a layer of monomers intended for polymerization positioned on the surface of the substrate via, for instance, a monomer solution for later grafting onto the surface of the substrate. In some embodiments, for example, the graft monomer layer may comprise at least one of an acrylate monomer, a methacrylate monomer, vinyl acetate, acrylonitrile, acrylamide, acrylic acid, or any combination thereof. In this regard, the graft monomer layer may include one or more of these materials. In some embodiments, for instance, the graft monomer layer may comprise at least one of a fluoroacrylate or a siloxane acrylate. In other embodiments, for example, the graft monomer layer may comprise at least one of acrylamide, acrylic acid, methyl acrylate, methyl methacrylate, ethyl acrylate, ethyl methacrylate, hydroxyethyl acrylate, hydroxyethyl methacrylate (HEMA), (3-acrylomidopropyl) trimethylammonium (APTA), butyl acrylate, glycidyl acrylate, acryloyl chloride, (2-dimethylamino)ethyl methacrylate, methacrylic acid, ethylene glycol methyl ether acrylate, diethylene glycol methyl ether methacrylate, poly(ethylene) methyl ether acrylate, 3-sulfopropyl acrylate sodium salt, [2-(methacryloyloxy)ethyl]dimethyl-(3-sulfopropyl)ammonium hydroxide, [2-(methacryloyloxy)ethyl]trimethylammonium chloride, [2-(acryloyloxy)ethyl]trimethylammonium chloride, [3-(methacryloylomino)propyl]trimethylammonium chloride, 3-(acrylomidopropyl)trimethylammonium chloride, or any combination thereof.

According to certain embodiments, for instance, selectively removing discrete portions of the graft monomer layer may be performed via photolithography. In some embodiments, a photomask having distinct portions designed to block UV radiation may be placed over the graft monomer layer such that when the graft monomer layer undergoes UV irradiation, the portions of the graft monomer layer not blocked from UV radiation by the photomask may be removed.

In accordance with certain embodiments, living chain-grown polymerization (e.g., RAFT) may provide a fast and reversible propagation/termination reaction for precise control of polymer molecular weight, molecular weight dispersity, and chain architecture. RAFT polymerization in particular may be used due to its ability to work with a wide variety of monomers and solvents. As understood by one of ordinary skill in the art, the RAFT chain transfer agent may be selected to correspond with the target monomer/solvent combination. In this regard, the resulting polymer molecular weight may be determined by the reaction conditions and relative ratio of initial RAFT chain transfer agent to monomer concentration. In some embodiments, for example, the RAFT chain transfer agent may comprise 2-(1-carboxy-1-methyl-ethyl sulfanylthiocarbonyl sulfanyl)-2-methyl-propionic acid (CMP), although any suitable RAFT chain transfer agent as understood by one of ordinary skill in the art may be used. In further embodiments, for instance, the ratio of monomer concentration to RAFT chain transfer agent concentration may comprise from about 100:1 to about 2000:1. In other embodiments, for example, the ratio of monomer concentration to RAFT chain transfer agent concentration may comprise from about 120:1 to about 800:1. In further embodiments, for instance, the ratio of monomer concentration to RAFT chain transfer agent concentration may be greater than or equal to 150:1. As such, in certain embodiments, the ratio of monomer concentration to RAFT chain transfer agent concentration may comprise at least about any of the following: 100:1, 105:1, 110:1, 115:1, 120:1, and 150:1 and/or at most about 2000:1, 1900:1, 1800:1, 1700:1, 1600:1, 1500:1, 1400:1, 1300:1, 1200:1, 1100:1, 1000:1, 900:1, and 800:1 (e.g., about 120-1600:1, about 150-900:1, etc.). Example RAFT polymerizations are shown below in Scheme 1:

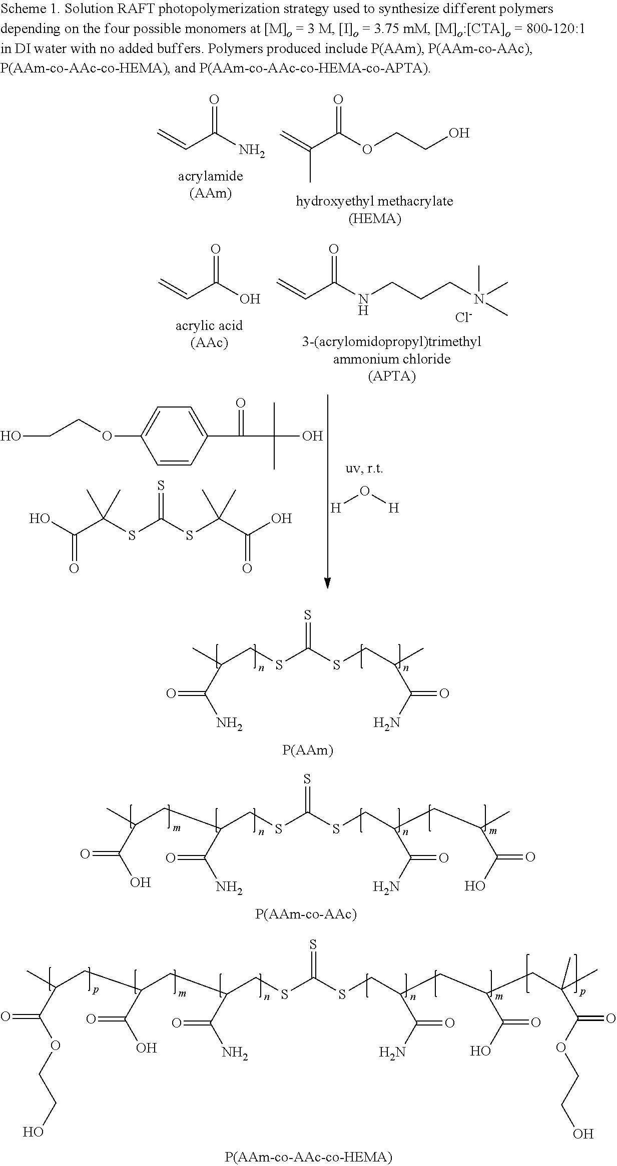

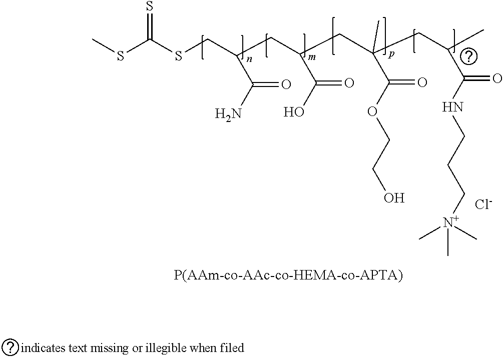

In accordance with certain embodiments, for example, RAFT polymerization may result in a percent conversion of monomers to polymers from about 25 to about 99%. In further embodiments, for instance, the percent conversion of monomers to polymers may be from about 30 to about 99%. In other embodiments, for example, the percent conversion of monomers to polymers may be from about 50 to about 99%. In some embodiments, for instance, the percent conversion of monomers to polymers may be from about 70 to about 99%. As such, in certain embodiments, the percent conversion of monomers to polymers may be from at least about any of the following: 25, 30, 35, 40, 45, 50, 55, 60, 65, and 70% and/or at most about 99% (e.g., about 65-99%, about 70-99%, etc.).

According to certain embodiments, for example, the polymers may comprise a number average molecular weight (Mₙ) from about 1 to about 85 kg/mol. In some embodiments, for instance, the polymers may comprise a Mₙ from about 10 to about 60 kg/mol. In further embodiments, for example, the polymers may comprise a Mₙ from about 20 to about 50 kg/mol. As such, in certain embodiments, the polymers may comprise a Mₙ from at least about any of the following: 1, 5, 10, 15, and 20 kg/mol and/or at most about 85, 80, 75, 70, 65, 60, 55, and 50 kg/mol (e.g., about 15-75 kg/mol, about 20-85 kg/mol, etc.).

In accordance with certain embodiments, for example, the plurality of graft polymers may be grafted to the substrate via ultraviolet (UV) initiated grafting. In other embodiments, however, grafting may occur via any other suitable method including, but not limited to, corona discharge, oxygen plasma, UV/ozone, silane coupling, acid/base treatment, and/or any other free radical initiator source as understood by one of ordinary skill in the art. In some embodiments, UV initiated grafting may utilize one or more aromatic ketones such as benzophenone to abstract hydrogen to produce surface anchored radical species. In some embodiments, for instance, as part of the UV initiated grafting process, the plurality of graft polymers may be exposed to UV light for a treatment time of about 4 to about 30 minutes. The ideal time for UV light exposure may vary due to several variables, including the strength of the UV light, the target biofouling organism, the target pattern shape and size, and/or the like. A sample UV grafting mechanism is shown below in Scheme 2:

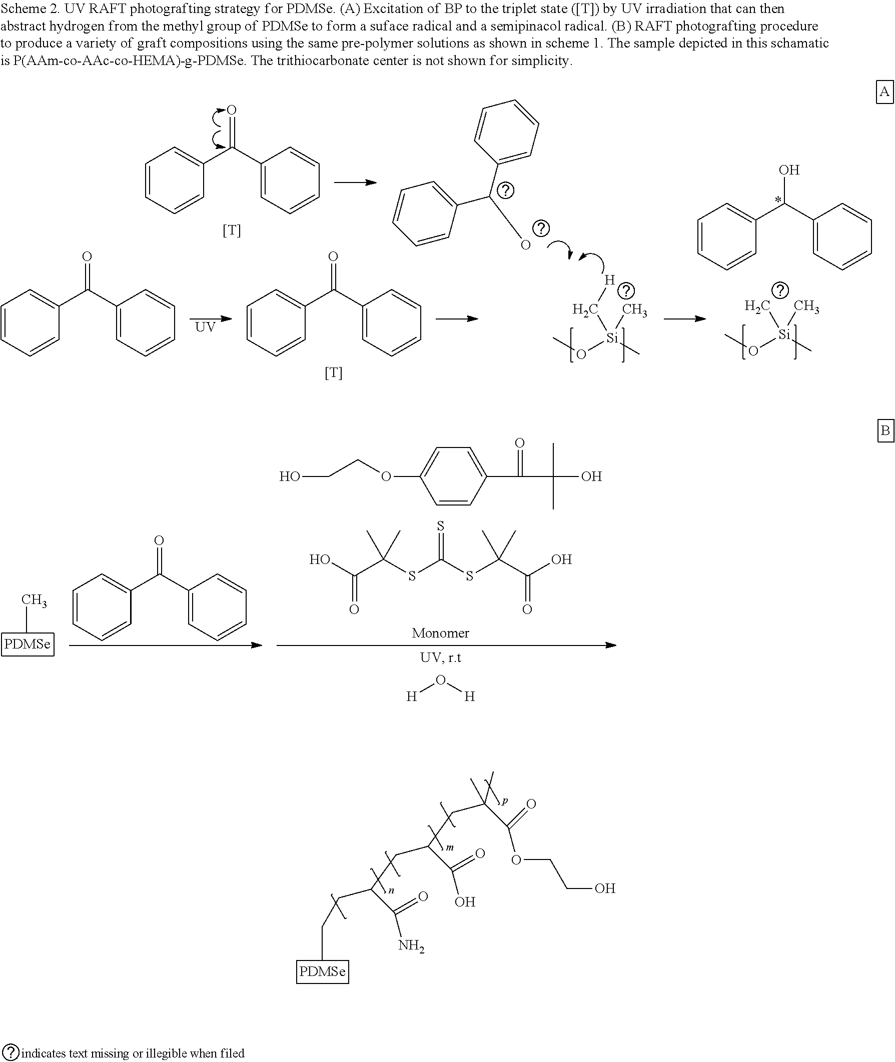

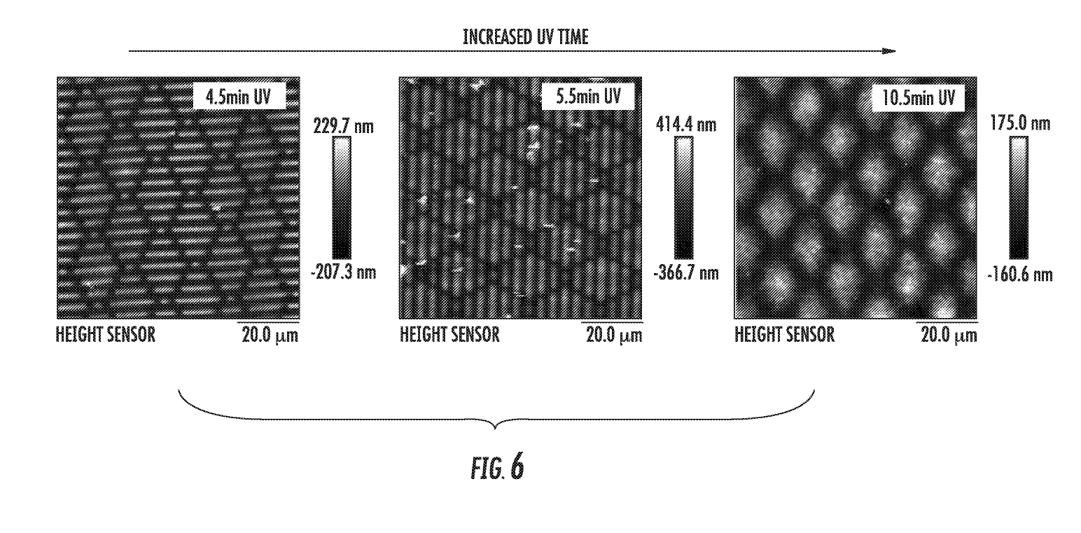

FIGS. 5 and 6, for instance, illustrate the effect of UV polymerization time on the chemical pattern in accordance with certain embodiments of the invention. As shown in FIG. 5, as the UV exposure time increased in P(AAm)-g-PDMSe samples, the height of the polymer chains on the substrate increased. As the height increased, the lateral distance between portions of the pattern decreased, resulting in a less clearly defined pattern. FIG. 6 provides clearer images of the progression of the polymer growth and pattern distortion with increased UV time. In particular, in the left image of FIG. 6, pattern fidelity is maintained at short polymerization times. The middle image of FIG. 6 illustrates how increasing UV time increases feature heights with a corresponding increase in feature width. Finally, the right image of FIG. 6 shows that at a critical UV polymerization time, the growth in feature width causes the features to merge together.

According to certain embodiments, for instance, the anti-biofouling coating may further comprise a biocidal agent. In some embodiments, for example, the biocidal agent may be grafted to the substrate either along with or as part of the plurality of graft polymers. In further embodiments, for instance, the biocidal agent may comprise comprise any of a number of pesticides and/or antimicrobials, including but not limited to fungicides, herbicides, algicides, molluscicides, germicides, antibiotics, antibacterials, antivirals, antifungals, antiprotozoals, antiparasites, and/or the like. In particular, the biocidal agent may comprise any number of monomers, copolymers, ternary copolymers, and/or the like having biocidal properties, including, but not limited to, for example, quaternary ammonium salts. Examples of quaternary ammonium salts that may be used as biocidal agents include, but are not limited to, [2-(acryloyloxy)ethyl]trimethylammonium chloride solution, dodecyltrimethylammonium methacrylate, hexadecyltrimethylammonium acrylate, [3-(methacryloyoamino)propyl]trimethylammonium chloride solution, [2-(methacryloyloxy)ethyl]trimethylammonium chloride solution, [3-(methacryloylamino)propyl]dimethyl(3-sulfopropyl)ammonium hydroxide inner salt, (vinylbenzyl)trimethylammonium chloride, (3-acrylamidopropyl)trimethylammonium chloride (APTA), benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, quaternary ammonium salts having C16-C26 alkyl chains, and/or the like.

In accordance with certain embodiments, and as discussed herein, the anti-biofouling coating may comprise a plurality of polymers grafted to the surface of the substrate. In some embodiments, for example, the plurality of polymers may comprise a molecular weight (M_{w}) from about 1 to about 200 kg/mol. According to certain embodiments, the surface energy of the anti-biofouling coating may depend on graft chemistry. In some embodiments, for example, the anti-biofouling coating may comprise a surface energy from about 23 to about 70 mJ/m².

According to certain embodiments, for instance, the plurality of polymers may comprise a dispersity (Ð) of less than about 1.50. In some embodiments, for example, the polymers may comprise Ð from about 1.00 to about 1.15. In further embodiments, for instance, the polymers may comprise Ð from about 1.01 to about 1.13. As such, in certain embodiments, the polymers may comprise (Ð) from at least about any of the following: 1.00 and 1.01 and/or at most about 1.50, 1.45, 1.40, 1.35, 1.30, 1.25, 1.20, 1.15, 1.14, and 1.13 (e.g., about 1.00-1.40, about 1.01-1.14, etc.).

### III. Methods of Directing Bioadhesion

In another aspect, certain embodiments according to the invention provide methods of directing bioadhesion on a base surface. According to certain embodiments, the method includes providing a directed bioadhesion coating on the base surface, such that the directed bioadhesion coating comprises a substrate and a plurality of graft polymers grafted on the substrate. As previously discussed, the plurality of graft polymers define a chemical pattern on the substrate.

In accordance with certain embodiments, the base surface may include a boat hull, a bridge, a power generating facility, a medical implant (e.g., an orthopedic prosthesis, an artificial heart valve, an artificial vascular graft, etc.), a cosmetic implant (e.g., a breast implant), and/or the like. Although examples of base surfaces have been listed here, the base surface may be any surface subject to biofouling as understood by one of ordinary skill in the art.

According to certain embodiments, biofouling may occur as a result of numerous organisms. Examples of such organisms include, but are not limited to, diatoms (e.g., Navicula incerta), algae (e.g., Ulva linza), bacteria (e.g., Cellulophaga lytica), barnacles, crustaceans, tubeworms, mussels, and/or the like. The chemistry of the anti-biofouling coating may be selected based on its efficacy against a target organism, and the specific chemical pattern may similarly be selected to enhance the efficacy of the chemistry. Similarly, the chemistry of the anti-biofouling coating and the specific chemical pattern may be selected for the industry and/or use of the anti-biofouling coating. For example, the chemistry and chemical pattern may differ among marine, medical, and microfluidic applications.

### EXAMPLES

The following examples are provided for illustrating one or more embodiments of the present invention and should not be construed as limiting the invention.

### Example 1

Platinum-catalyzed Xiameter® RTV-4232-T2 two-part PDMS resin was purchased from Dow Corning, borosilicate microscope glass slides (76 mm×25 mm×1 mm) were purchased from Fisher Scientific, and fused quartz plates (ground and polished, 3.5 in×3.5 in×0.062 in) were purchased from Technical Glass Products. Acrylic acid (99 wt. % with 200 ppm of monomethyl ether of hydroquinone (MEHQ)) (AAc), acrylamide (>99 wt. %) (AAm), hydroxyethyl methacrylate (97 wt. % with 250 ppm MEHQ) (HEMA), (3-acrylomidopropyl) trimethylammonium chloride solution (75 wt. % in H₂O with 3000 ppm MEHQ) (APTA), and benzophenone (≥99 wt. %) (BP) were purchased from Sigma-Aldrich. 1-[4-(2-hydroxyethoxy)-phenyl]-2-hydroxy-2-methyl-1-propane-1-one (Irgacure 2959) was purchased from Ciba.

2-(1-Carboxy-1-methyl-ethylsulfanylthiocarbonylsulfanyl)-2-methyl-propionic acid) (CMP) was synthesized. Briefly, a solution of 4.5 mM acetone, 4.5 mM chloroform, 1.8 mM carbon disulfide, and 0.0178 mM tetrabutyl ammonium chloride in hexane (40 mL) was prepared. A 25 mM NaOH in water (20 mL) solution was added dropwise over 90 min to the reaction mixture cooled in an ice bath while stirring under argon. The mixture was then reacted for 12 h, after which the formed solids were dissolved by the addition of ˜180 mL of DI water. Next, ˜20 mL of 12.1 M hydrochloric acid was added dropwise to the mixture, while ensuring that the pH of the solution never dropped below pH=2, and reacted for 30 min while stirring under argon. The resultant yellow solids were filtered, washed with DI water, and purified by recrystallization 3× from acetone. CMP structure was confirmed by FTIR and ¹³C-NMR.

AAm was recrystallized 3× from chloroform and vacuum dried, and BP was recrystallized 3× from acetone and vacuum dried. All other materials were used as received from the manufacturer. Deionized (DI) water (18.2 Me-cm) was produced in-house (Millipore Milli-Q).

A pre-polymer solution consisting of 3 M monomer, 253.75 mM CMP (800-120:1 [M]o:[CMP]o), and 3.75 mM Irgacure 2959 in DI water was prepared. The chosen monomers included AAm, AAc, HEMA, and APTA, and co-monomer solutions used equal molar ratios of the individual monomers. A total of four polymers were produced: P(AAm), P(AAm-co-AAc), P(AAm-co-AAc-co-HEMA), and P(AAm-co-AAc-co-HEMA-co-APTA). 50 μL ethanol/1 mL solution was added to pre-polymer solutions with a CMP concentration ≥150:1 [M]o:[CTA]o in order to fully solubilize CMP.

A Lesco CureMax FEM1011 UV curing system equipped with an Osram ULTRA VITALUX UVA/UVB bulb (300 W, 230 V) outputting 10.01±0.61 mW/cm2 was used for all polymerizations. The pre-polymer solution was de-gassed for >30 min by bubbling with UHP N2 gas, and 1-2 mL of 0.45 μm filtered solution was UV treated between quartz plates separated by 1.55 mm spacers for varying treatment times. The resultant polymer/monomer solution was washed extensively from the plates with DI water, purified by dialysis (3.5 kg/mol MWCO) in DI water for two days, and dried via rotary evaporation at 40° C. Polymer % conversion was estimated gravimetrically.

PDMSe was prepared and attached to glass microscope slides resulting in a ˜600 μm thick PDMSe film attached to glass. PDMSe coated microscope slides were cleaned by 3 successive washes with acetone and ethanol then dried with UHP N2 gas. Samples were immersed in a 10% (wt. %) solution of BP in methanol for 30 min, lightly washed (1-2 sec) with methanol, and dried with UHP N2. BP coated PDMSe slides were placed onto a glass plate containing 4 1.55 mm rubber spacers, and 1 mL of degassed 0.45 μm filtered pre-polymer solution (same as discussed above) was pipetted onto the sample surface. A quartz plate was positioned onto the 4 spacers to evenly distribute the solution forming a thin pre-polymer layer against the PDMSe sample. Samples were photografted by UV irradiation for a set amount of time (2-15 min) and then removed. The resultant bulk polymer/monomer solution was collected and purified in the same manner as discussed above.

To ensure removal of all un-reacted monomer, non-grafted polymer, and residual BP from PDMSe, photografted PDMSe samples were washed for 24 h in DI water (160 mL, replaced DI water 4×), sonicated in methanol for 2 h (160 mL, replaced methanol 1×), and sonicated in DI water for 2 h (160 mL, replaced water 1×) at 55° C. Grafted PDMSe samples are labeled as P(co-monomer)-g-PDMSe using polymer graft designations as indicated by the monomers utilized in the pre-polymer solution.

GPC of purified polymer was performed using a miniDAWN™ TREOS multi-angle LS system (Wyatt Technologies), a 2414 differential refractive index (dRI) detector (Waters Corporation), and a Ultrahydrogel 250 column (Waters Corporation) in aqueous 0.1 M NaNO3 at a flow rate of 0.5 mL/min and concentrations of 2.5 mg/mL. Polymers with MW's larger than 80 kg/mol were analyzed using a Ultrahydrogel Linear column (Waters corporation) in line with a Viscotek A5000 column (Malvern). MW calculations were performed using ASTRA 6.1 software (Wyatt Technologies), and analysis was verified using PEO standards (20 kg/mol<MP<72 kg/mol, Ð<1.1) (Agilent). Polymer do/dc was estimated by assuming 100% conversion by the dRI detector.

ATR-FTIR spectroscopy was performed using a Nicolet 6700 FT-IR spectrometer (Thermo-Fisher Scientific) equipped with a germanium crystal. A total of 32 scans per spectrum were acquired with a resolution of 4 cm⁻¹, data spacing of 0.482 cm⁻¹, and maximum peak background interferogram value of 4.00±0.25. A background spectrum in air was collected and subtracted from the collected spectrum of each sample. Static water contact angle (CA) was performed using a custom designed goniometer system that utilized a 150× lens with a 5 mm field of view (Edmund Optics) to image a 5 μL DI water droplet applied to the sample surface via a needle connected to a computerized syringe pump. Image J analysis was used to calculate the contact angle of the droplet. 5 droplets per surface (n=5) with at least 3 surfaces per coating type/graft condition (N=3) were performed. A Dimension Icon AFM (Bruker) was used to analyze the surface topography of hydrated samples submerged in DI water using ScanAsyst® fluid+ tips (Bruker) and in atmospheric air using ScanAsyst® air tips (Bruker) using ScanAsyst® mode. NanoScope Analysis software (Bruker) was used to visualize all AFM scans and to calculate surface nanoroughness.

UV-initiated solution polymerizations of copolymers of AAm, AAc, HEMA, and APTA at varying [M]o/[CMP]o were performed to determine CMP's effectiveness as a RAFT CTA under aqueous UV conditions, as shown in Table 1.

TABLE 1
Aqueous RAFT solution polymerization data at constant UV time of 20 min.

| | | | M_{n,theoretical} | M_{n,experimental} | |
|---|---|---|---|---|---|
| Sample | ₒ[M]:[CTA]ₒ | % Conversion^{a} | (kg/mol)^{b} | (kg/mol) | Ð |
| P(AAm) | 800:1 | 98.7 | 56.6 | 47.8 (2.2) | 1.09 |
| | | | | | (0.06) |
| P(AAm) | 375:1 | 88.4 | 23.8 | 20.1 (1.9) | (1.04) |
| | | | | | (0.14) |
| P(AAm) | 150:1 | 73.4 | 8.0 | 7.8 (1.5) | 1.07 |
| | | | | | (0.36) |
| P(AAm-co-AAc) | 800:1 | 82.8 | 45.6 | 43.8 (1.5) | 1.03 |
| | | | | | (0.05) |
| P(AAm-co-AAc) | 375:1 | 76.1 | 20.6 | 20.7 (1.3) | 1.01 |
| | | | | | (0.09) |
| P(AAm-co-AAc) | 150:1 | 56.5 | 6.3 | 7.9 (1.0) | 1.13 |
| | | | | | (0.27) |
| P(AAm-co-AAc-co-HEMA) | 800:1 | 75.3 | 54.2 | 77.0 (0.9) | 1.06 |
| | | | | | (0.04) |
| P(AAm-co-AAc-co-HEMA) | 625:1 | 25.0 | 14.5 | 28.0 (1.7) | 1.10 |
| | | | | | (0.02) |
| P(AAm-co-AAc-co-HEMA) | 300:1 | 33.5 | 9.1 | 13.1 (1.1) | 1.10 |
| | | | | | (0.14) |
| P(AAm-co-AAc-co-HEMA) | 120:1 | 35.7 | 4.2 | 4.8 (0.6) | 1.11 |
| | | | | | (0.24) |
| P(AAm-co-AAc-co-HEMA- | 800:1 | 86.6 | 80.6 | 81.2 (1.7) | 1.11 |
| co-APTA)* | | | | | (0.03) |

P(AAm) and P(AAmAAc) formed at high conversions and low Ð (≤1.13) with well controlled Mₙ in good agreement with theoretically predicted Mₙ indicating successful RAFT polymerization. The addition of HEMA into the monomer system increased the experimental Mₙ significantly compared to the theoretical value, most likely due to different re-initiation and fragmentation efficiencies of methacrylate and acrylate groups. Yet, D remained low and the overall control of Mₙ by varying [CTA]o was superior to uncontrolled, non-living techniques. In addition, the overall % conversion values obtained for P(AAm-co-AAc-co-HEMA) were lower than similar experiments performed using the other monomer systems suggesting that HEMA may promote higher termination rates. The incorporation of APTA into the copolymer increased the conversion and Mₙ control back to the level seen with P(AAm) and P(AAm-co-AAc), showing that even four monomer systems can be successfully polymerized via a robust RAFT process. Decreasing the [M]o/[CTA]o ratio reduced the maximum conversion for all polymer systems, suggesting that excess CTA can retard polymerization.

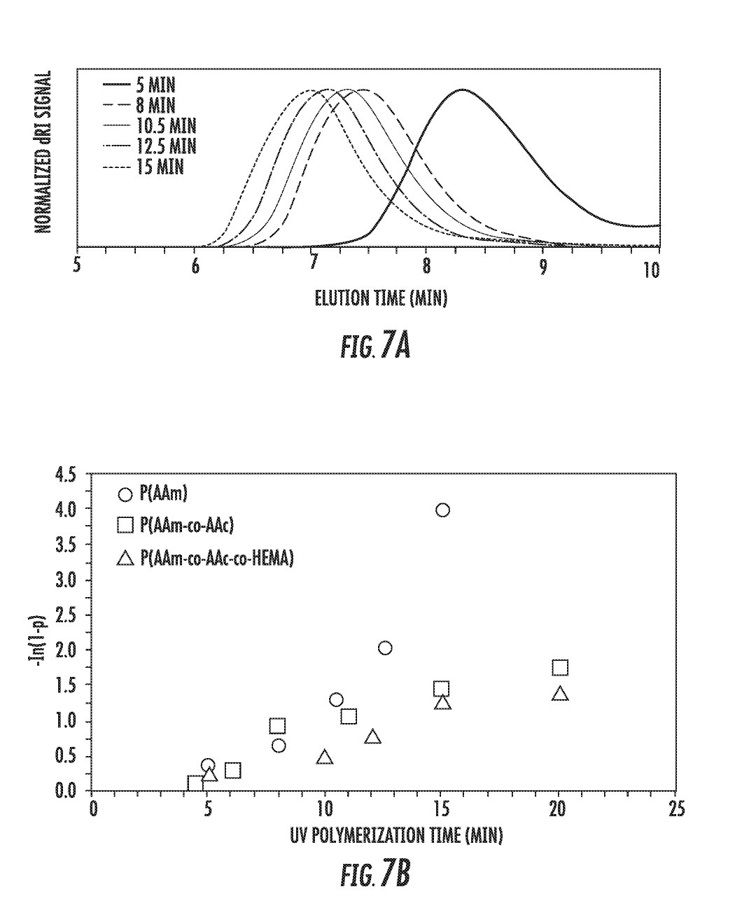

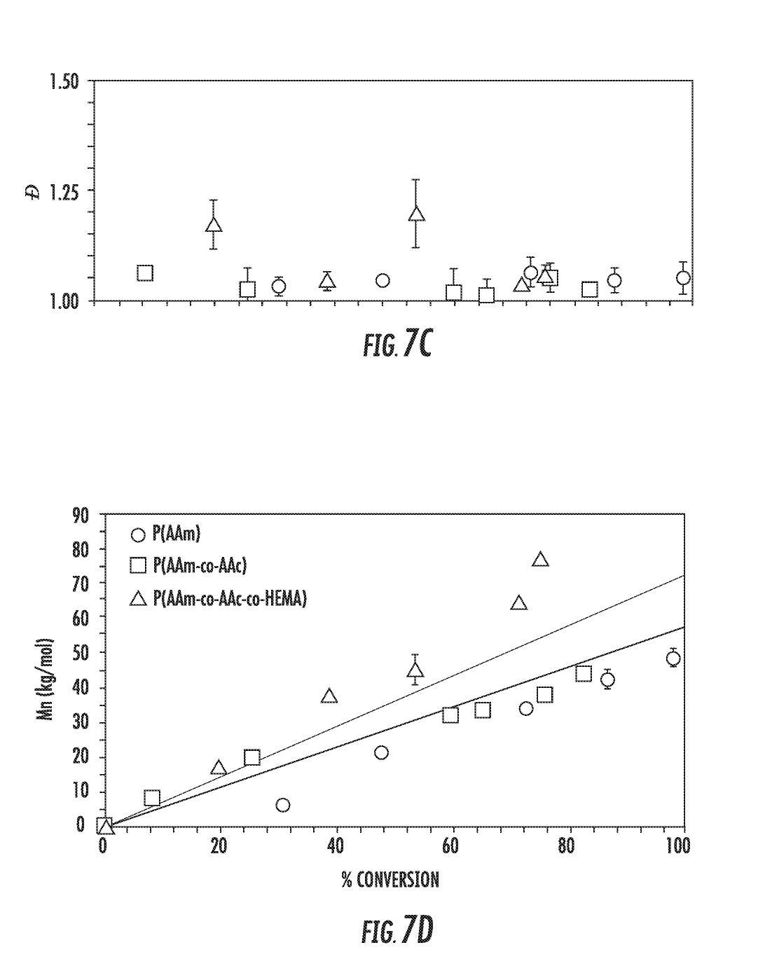

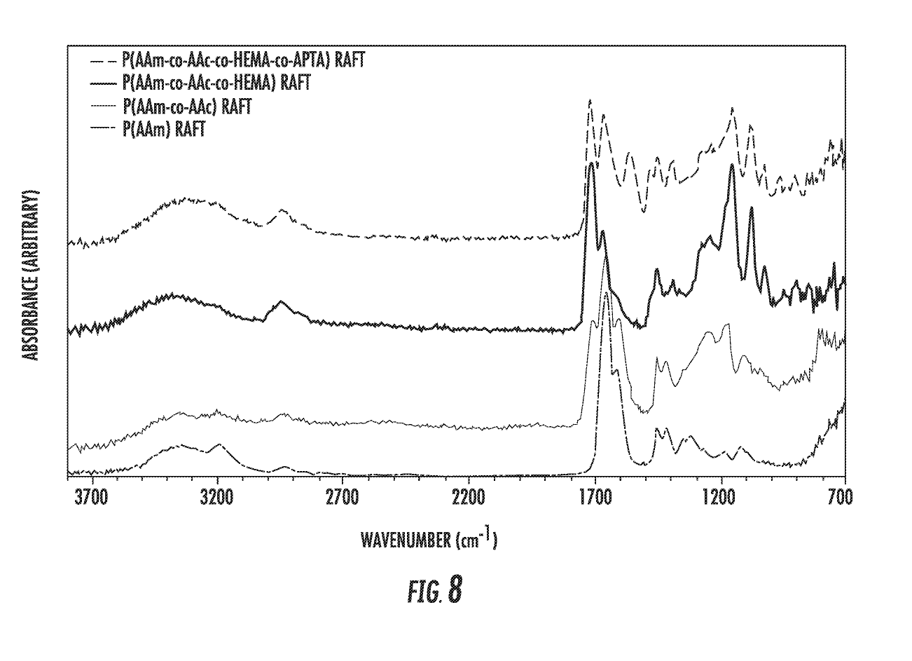

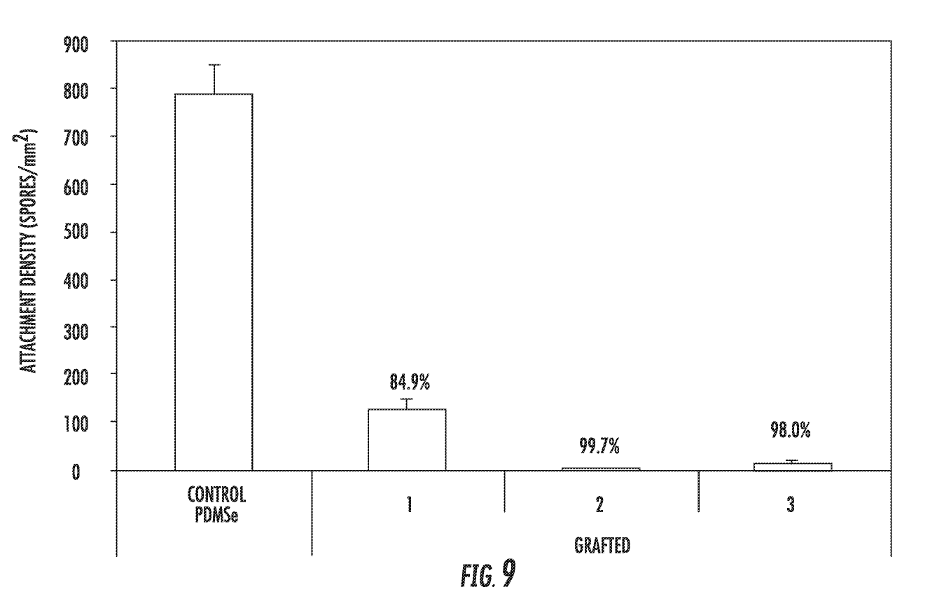

The shape and distribution of the P(AAm), P(AAm-co-AAc-co-HEMA), and P(AAm-co-AAc-co-HEMA-co-APTA) GPC chromatograms did not have shoulders indicating no significant early polymer chain termination, as shown in FIG. 7A; however, P(AAm-co-AAc) did show a slight shoulder, suggesting the presence of a small amount of higher MW polymer present, likely due to termination reactions between two growing polymer chains. Linear pseudo first-order kinetics are observed for the polymerizations of AAm, AAc, and HEMA, as shown in FIG. 7B. However, some curvature was present at higher conversions of AAm, and all polymerizations showed a short inhibition period of ˜3-4 min. AAm and AAm copolymerized with AAc have similar polymerization rates at low conversion, and incorporating HEMA into the copolymer slows the reaction. The polymerization of AAm achieved almost complete conversion (>99%) while P(AAm-co-AAc) and P(AAm-co-AAc-co-HEMA) were limited to 83% and 75% conversions, respectively. The conversion was not increased further by UV treatment times >20 min.

Also evident from Table 1 and FIG. 7C are the consistently low Ð values measured for AAm, AAc, and HEMA copolymer systems. The expected linear increase in Mₙ with % conversion is observed and is another indicator of successful RAFT polymerization, as shown in FIG. 7D; however, the experimental Mₙ values deviate from theoretical predictions. P(AAm) and P(AAm-co-AAc) experimental values are generally below theoretical and vice versa for P(AAm-co-AAc-co-HEMA). Similar kinetic tests were not performed on the P(AAm-co-AAc-co-HEMA-co-APTA) system due to challenges with grafting to PDMSe that will be discussed in detail later.

ATR-FTIR analysis of the RAFT-synthesized copolymers confirmed that the respective monomer constituents were successfully incorporated into the targeted polymer, as shown in FIG. 8. All polymers had absorbance peaks at ˜2920 (CHX asym. stretch) and ˜1450 cm⁻¹ (CH2 stretch) from the polymer backbone. AAm was confirmed via ˜3345 and 3194 cm⁻¹ (—NH2 stretch) and 1664 and 1610 cm⁻¹ (—CO—NH2 stretch and bend, respectively) absorbance peaks. New absorbance peaks centered at ˜3300 (—OH stretch) and ˜1709 cm⁻¹ (—CO—OH stretch) were detected in P(AAm-co-AAc) from AAc, and the incorporation of HEMA was determined via new peaks at 1158, 1080, and 1020 cm⁻¹ (C—O—C stretch) and a 1722 cm⁻¹ (—CO—O—CH2- stretch) that overlapped with the 1709 cm⁻¹ AAc peak to produce a convoluted 1716 cm⁻¹ peak. The four component copolymer showed each of the previous peaks plus peaks centered at 1558 cm⁻¹ (CO—NH—C—) and 1482 cm⁻¹ (—N+-(CH3)3) from APTA.

### Example 2

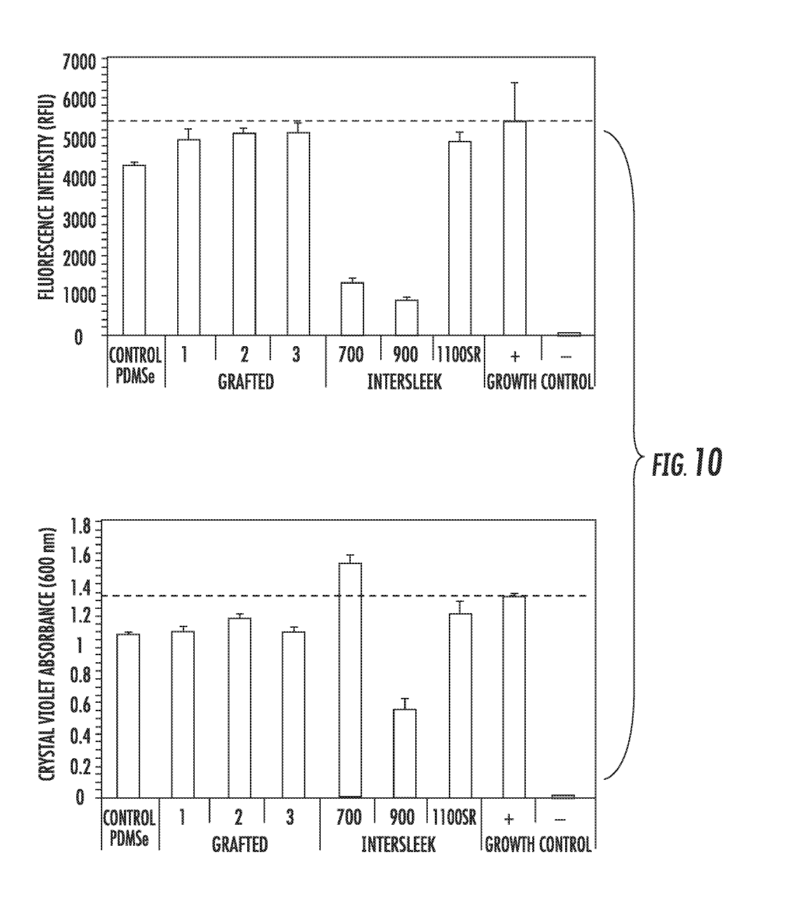

FIG. 9 illustrates U. linza attachment density on PDMSe surfaces in accordance with certain embodiments of the invention. Test coatings were sterilized by three washes in 70% isopropyl alcohol (IPA) and DI water. Coatings were equilibrated in 0.22 μm filtered artificial seawater (ASW) for 24 h prior to testing. Zoospores were obtained from mature plants of U. linza. A suspension of zoospores was prepared with OD600 nm=0.15 (equivalent to 1.10⁶ spores ml⁻¹) from which 10 ml were added to individual compartments of quadriPERM dishes containing the samples. The slides were washed by passing 10× through a beaker of ASW to remove unsettled (i.e. swimming) spores after 45 min in darkness at ˜20° C. Slides were fixed using 2.5% glutaraldehyde in ASW. The density of zoospores attached to the surface was counted using AxioVision 4 software (https://www.zeiss.com/microscopy.html) attached to a Zeiss Axioskop fluorescence microscope (Zeiss, Oberkochen, Germany). Spores were visualized by autofluorescence of chlorophyll. Counts were made for 30 fields of view (each 0.15 mm²) on each slide on three replicate slides per coating type. As-cast PDMSe coatings were used as control standards.

As shown in FIG. 9, all grafted surfaces demonstrated excellent anti-biofouling capacity. In particular, FIG. 9 illustrates that the specific graft chemistry is a significant factor in attachment density. Grafted surface 1 corresponds to P(AAm)-g-PDMSe, grafted surface 2 corresponds to P(AAm-co-AAc)-g-PDMSe, and grafted surface 3 corresponds to P(AAm-co-AAc-co-HEMA)-g-PDMSe. As shown in FIG. 9, The grafted surfaces made of P(AAm-co-AAc)-g-PDMSe provided the best protection against biofouling, followed by P(AAm-co-AAc-co-HEMA)-g-PDMSe and P(AAm)-g-PDMSe, respectively. The control PDMSe surface provided very little protection against biofouling.

Similarly, FIG. 13 illustrates algal spore attachment density of U. linza on poly(acrylamide) patterned PDMSe substrates in accordance with certain embodiments of the invention. In FIG. 13, inset percentages show the percent change in attachment density compared to the PDMSe smooth control. As shown in FIG. 13, the P(AAm) substrate showed the greatest changed in attachment density compared to the PDMSe smooth control.

### Example 3

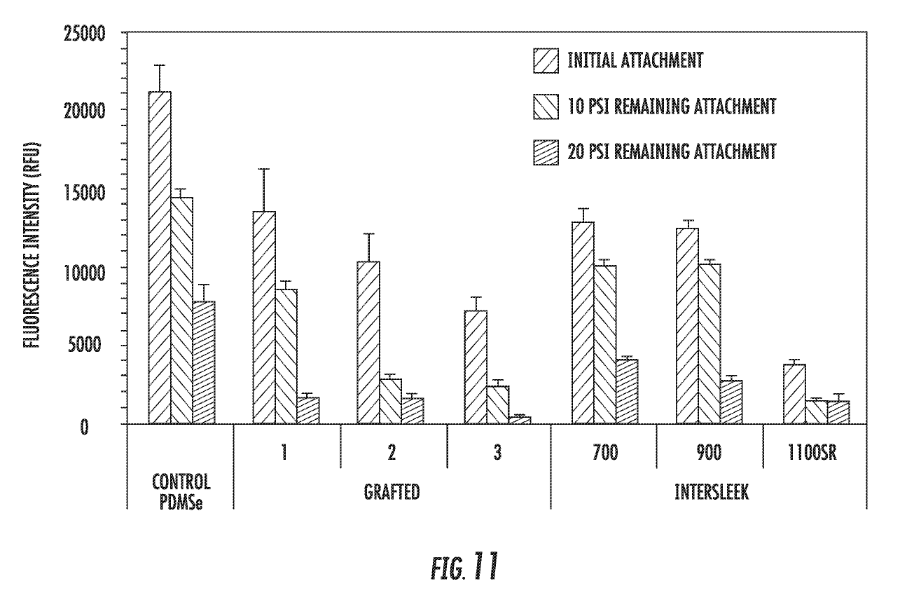

FIG. 10 illustrates leachate toxicity comparison for test surfaces compared to positive (growth media) and negative (triclosan) growth controls in accordance with certain embodiments of the invention. Sample leachate toxicity against N. incerta was assessed by introducing diatoms into overnight extracts (ASW with nutrients) of treatment coatings and evaluating growth after 48 h via fluorescence of chlorophyll (FIG. S8). Growth in coating leachates was reported as a fluorescence ratio compared to a positive growth control (fresh nutrient medium) and a negative growth control (medium+bacteria +6 μg/ml triclosan). PCAgPDMS samples displayed no evidence of leachate toxicity; however, IS700 and IS900 samples showed mild toxicity despite the 7 day tap water immersion. PCAgPDMS coatings did not impact the 48 h biofilm growth compared to the PDMSe control, but IS700 and IS900 showed diminished growth likely due to their mild toxicity. Sample leachate toxicity against C. lytica was similarly assessed. In the top graph of FIG. 10, the leachate was tested against N. incerta, and in the bottom graph of FIG. 10, the leachate was tested against C. lytica. Grafted surface 1 corresponds to P(AAm)-g-PDMSe, grafted surface 2 corresponds to P(AAm-co-AAc)-g-PDMSe, and grafted surface 3 corresponds to P(AAm-co-AAc-co-HEMA)-g-PDMSe. As shown in FIG. 10, none of the grafted surfaces showed signs of leaching toxic compounds.

### Example 4

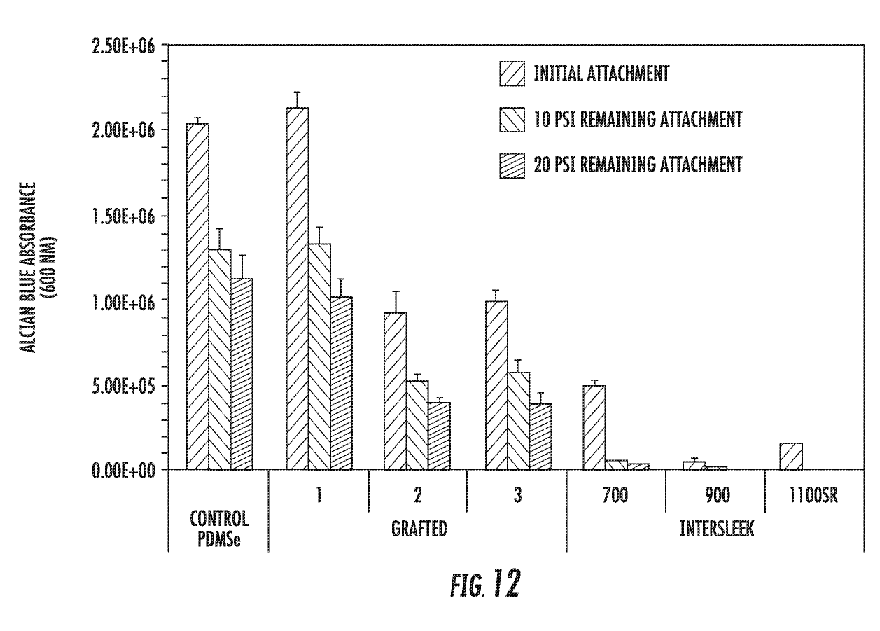

FIG. 11 illustrates biomass of N. incerta following various conditions on grafted and non-grafted surfaces in accordance with certain embodiments of the invention. In particular, FIG. 11 shows the biomass of N. incerta after 2 hours of initial attachment, application of a 10 psi water jet, and application of a 20 psi water jet. Samples were sterilized in the same fashion as those used for U. linza zoospore settlement in Example 2. Coatings were equilibrated in 0.22 μm filtered ASW for 24 h prior to testing. Cells of the diatom N. incerta were cultured in F/2 medium contained in 250 ml conical flasks. After three days the cells were in log phase growth. Cells were washed 3× in fresh medium before harvesting and diluted to give a suspension with a chlorophyll a content of approximately 0.25 μg ml⁻¹. For initial attachment measurements, diatoms were settled on three replicates of each coating in individual quadriPERM dishes containing 10 ml of suspension at ˜20° C. on the laboratory bench. After 2 h the quadriPERM dishes containing the slides were exposed to 5 min of shaking on an orbital shaker (60 rpm). Detached cells were then removed by immersion of the dishes in a basin of seawater in which individual slides were moved backwards and forwards six times (the immersion process avoided passing the samples through the air-water interface). Samples were fixed in 2.5% glutaraldehyde in ASW and air-dried. The density of cells attached to the surface was counted on each slide using an image analysis system attached to a fluorescence microscope. Counts were made for 30 fields of view on each slide as for U. linza described previously.

For strength of attachment, a further three replicates of each coating were settled with cells of N. incerta as described above. Slides with attached cells were exposed to a shear stress of 26 Pa for 5 min in a water channel. The turbulent flow water channel produces removal forces similar to those experienced around the hull of a ship, and the specific shear stress was chosen because it was sufficient to remove a reasonable proportion of the diatoms from the surfaces and allow differences in adhesion strength to be observed. After water channel exposure, samples were fixed and the number of cells remaining attached was counted using the same image analysis system described previously. As-cast PDMSe coatings were used as control standards.

Samples were removed from glass microscope slides using a razor blade and 15 mm disks were punched out and adhered to the bottom of 24-well plates using Dow Corning RTV sealant. Test coatings were sterilized by three washes in 70% IPA and DI water. Coatings were preconditioned in running tap water for seven days followed by 24 h in ASW prior to testing.

For biofilm growth, cells of the diatom N. incerta were diluted to an OD of 0.03 at 660 nm in ASW supplemented with nutrients (Guillard's F/2 medium). One ml was added to each well of the plate and allowed to incubate for 48 h at 18° C. with a 16:8 light:dark cycle in an illuminated growth cabinet (VWR Diurnal Illumination Incubator, Model 2015, Radnor, Pa., USA; photon flux density 33 μmol m⁻² s⁻¹). Algal biofilm was measured by fluorescence measurement of chlorophyll a via DMSO extracts (excitation wavelength: 360 nm; emission wavelength: 670 nm).

For strength of attachment, diatoms were allowed to settle on test surfaces for 2 h as described above before water jetting to remove attached cells. The water jet nozzle applies a jet of water perpendicular to the coating surface and rotates during operation to produce a water flow that radiates out in all directions parallel to the coating surface. This water jet apparatus was designed to mimic similar water jets utilized by field testing laboratories funded by the US Office of Naval Research. The first column of each well plate was not water jetted and served as the measure of initial cell attachment. The second and third column for each coating was jetted for 10 s at an impact pressure of 69 and 138 kPa, respectively. Impact pressures were chosen to allow for easy discrimination between standard coatings. Microalgal adhesion was reported as a function of biomass remaining on the material surface (fluorescence of chlorophyll a measured in relative fluorescence units (RFU) after treatment with each pressure indicated).

As-cast PDMSe coatings were used as control standards. International Paint (Gateshead, UK) products FR coatings including the silicone based Intersleek (IS) IS700, fluoropolymer based IS900, and amphiphilic IS1100 Slime Release (SR) were synthesized at the testing laboratory per the manufacturer's instructions and included for comparative purposes to study the ability of PCAgPDMS to compete with commercially available coatings.

Grafted surface 1 corresponds to P(AAm)-g-PDMSe, grafted surface 2 corresponds to P(AAm-co-AAc)-g-PDMSe, and grafted surface 3 corresponds to P(AAm-co-AAc-co-HEMA)-g-PDMSe. The percentages of N. incerta removed by the 10 psi water jet and the 20 psi water jet for the control PDMSe surface, grafted surface, and existing commercial INTERSLEEK® products are as follows:

TABLE 2
% removal of N. incerta compared to non-grafted PDMSe controls.

| | % Removal | % |
|---|---|---|
| Sample | 10 psi | Removal 20 psi |
| Control | 32.0 (3.3) | 63.5 (5.8) |
| P(AAm)-g-PDMSe | 36.7 (4.6) | 88.3 (2.4) |
| P(AAm-co-AAc)-g-PDMSe | 73.1 (1.7) | 85.2 (4.2) |
| P(AAm-co-AAc-co-HEMA)-g-PDMSe | 66.3 (4.6) | 94.9 (1.1) |
| IS 700 | 21.3 (2.0) | 68.7 (0.8) |
| IS 900 | 19.2 (2.4) | 78.4 (1.5) |
| IS 1100SR | 60.5 (60.5) | 60.7 (12.1) |

As shown in Table 2 and FIG. 11, graft chemistry had a significant impact on inhibiting initial attachment and fouling release performance.

### Example 5

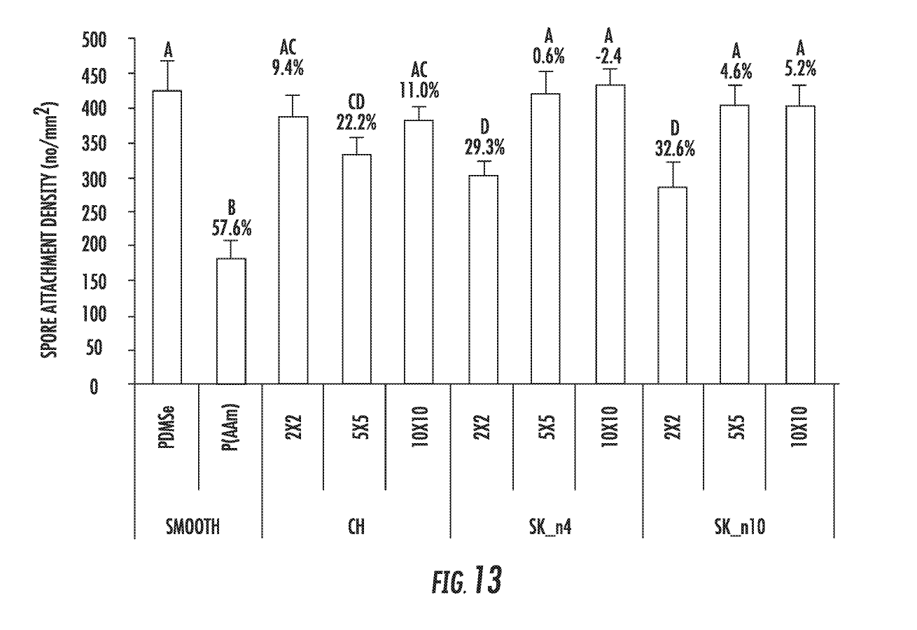

FIG. 12 illustrates biomass of C. lytica following various conditions on grafted and non-grafted surfaces in accordance with certain embodiments of the invention. In particular, FIG. 12 shows the biomass of C. lytica after 2 hours of initial attachment, application of a 10 psi water jet, and application of a 20 psi water jet. C. lytica testing was conducted in the same manner as that for N. incerta. Grafted surface 1 corresponds to P(AAm)-g-PDMSe, grafted surface 2 corresponds to P(AAm-co-AAc)-g-PDMSe, and grafted surface 3 corresponds to P(AAm-co-AAc-co-HEMA)-g-PDMSe. The percentages of C. lytica removed by the 10 psi water jet and the 20 psi water jet for the control surface, grafted surface, and existing commercial INTERSLEEK® products are as follows:

TABLE 3
% removal of C. lytica compared to non-grafted PDMSe controls.

| | % Removal | % |
|---|---|---|
| Sample | 10 psi | Removal 20 psi |
| Control | 36.3 (5.7) | 44.6 (6.3) |
| P(AAm)-g-PDMSe | 37.4 (4.4) | 52.1 (4.8) |
| P(AAm-co-AAc)-g-PDMSe | 43.8 (4.3) | 57.2 (3.3) |
| P(AAm-co-AAc-co-HEMA)-g-PDMSe | 42.1 (7.6) | 60.4 (6.4) |
| IS 700 | 89.1 (1.2) | 93.6 (2.7) |
| IS 900 | 82.4 (1.7) | 95.3 (1.0) |
| IS 1100SR | 96.2 (0.5) | 97.6 (1.4) |

As shown in Table 3 and FIG. 12, two of the three graft chemistries (i.e. P(AAm-co-AAc)-g-PDMSe and P(AAm-co-AAc-co-HEMA)-g-PDMSe) had a significant impact on inhibiting initial attachment and fouling release performance.

### NON-LIMITING EXEMPLARY EMBODIMENTS

Having described various aspects and embodiments of the invention herein, further specific embodiments of the invention include those set forth in the following paragraphs.

In one aspect, methods of forming a directed bioadhesion coating are provided. In accordance with certain embodiments of the invention, the method includes providing a substrate having a graft monomer layer on a surface thereof, selectively removing discrete portions of the graft monomer layer to expose the substrate surface, polymerizing any remaining portions of the graft monomer layer via reversible addition-fragmentation chain-transfer (RAFT) polymerization with a RAFT chain transfer agent to form a plurality of graft polymers, an simultaneously with polymerizing the remaining graft monomer layer, grafting the plurality of graft polymers to the substrate to form a chemical pattern on the substrate.

In accordance with certain embodiments, for example, providing the substrate having the graft monomer layer on the surface thereof may comprise providing the substrate and providing the graft monomer layer on the substrate. In some embodiments, for instance, providing the substrate may comprise providing at least one of a polypropylene, a polyethylene, polyethylene terephthalate, a silicone rubber, polyvinyl chloride, a polyamide, or any combination thereof.

According to certain embodiments, for example, the graft monomer layer may comprise a layer of at least one of an acrylate monomer, a methacrylate monomer, vinyl acetate, acrylonitrile, acrylamide, acrylic acid, or any combination thereof. In some embodiments, for instance, selectively removing discrete portions of the graft monomer layer may comprise photolithography. In further embodiments, for example, grafting the plurality of graft polymers to the substrate may comprise ultraviolet (UV) initiated grafting.

In accordance with certain embodiments, for instance, the method may further comprise grafting a biocidal agent to the substrate. In some embodiments, for example, the biocidal agent may comprise a quaternary ammonium salt.

In another aspect, directed bioadhesion coatings are provided. In accordance with certain embodiments of the invention, the directed bioadhesion coating includes a substrate and a plurality of graft polymers grafted on the substrate such that the plurality of graft polymers define a chemical pattern on the substrate.

In accordance with certain embodiments, for example, the directed bioadhesion coating may be formed by a method comprising providing the substrate having a graft monomer layer on a surface thereof, selectively removing discrete portions of the graft monomer layer to expose the substrate surface, polymerizing any remaining portions of the graft monomer layer via reversible addition-fragmentation chain-transfer (RAFT) polymerization with a RAFT chain transfer agent to form the plurality of graft polymers, and simultaneously with polymerizing the remaining graft monomer layer, grafting the plurality of graft polymers to the substrate to form the chemical pattern on the substrate.

According to certain embodiments, for instance, providing the substrate having the graft monomer layer on the surface thereof may comprise providing the substrate and providing the graft monomer layer on the substrate. In some embodiments, for example, the substrate may comprise at least one of a polypropylene, a polyethylene, polyethylene terephthalate, a silicone rubber, polyvinyl chloride, a polyamide, or any combination thereof.

According to certain embodiments, for instance, the graft monomer layer may comprise a plurality of at least one of an acrylate monomer, a methacrylate monomer, vinyl acetate, acrylonitrile, acrylamide, acrylic acid, or any combination thereof. In some embodiments, for example, selectively removing discrete portions of the graft monomer layer may comprise photolithography. In further embodiments, for instance, the plurality of graft polymers may be grafted onto the substrate via ultraviolet (UV) initiated grafting.

In accordance with certain embodiments, for example, the directed bioadhesion coating may further comprise a biocidal agent grafted to the substrate. In some embodiments, for instance, the biocidal agent may comprise a quaternary ammonium salt.

In yet another aspect, methods of directing bioadhesion on a base surface are provided. In accordance with certain embodiments of the invention, the method includes providing a directed bioadhesion coating on the base surface. The directed bioadhesion coating includes a substrate and a plurality of graft polymers grafted on the substrate such that the plurality of graft polymers define a chemical pattern on the substrate.

In accordance with certain embodiments, for example, the directed bioadhesion coating may be formed by a method comprising providing the substrate having a graft monomer layer on a surface thereof, selectively removing discrete portions of the graft monomer layer to expose the substrate surface, polymerizing any remaining portions of the graft monomer layer via reversible addition-fragmentation chain-transfer (RAFT) polymerization with a RAFT chain transfer agent to form the plurality of graft polymers, and simultaneously with polymerizing the remaining graft monomer layer, grafting the plurality of graft polymers to the substrate to form the chemical pattern on the substrate.

According to certain embodiments, for instance, providing the substrate having the graft monomer layer on the surface thereof may comprise providing the substrate and providing the graft monomer layer on the substrate. In some embodiments, for example, the substrate may comprise at least one of a polypropylene, a polyethylene, polyethylene terephthalate, a silicone rubber, polyvinyl chloride, a polyamide, or any combination thereof.

According to certain embodiments, for instance, the graft monomer layer may comprise a layer of at least one of an acrylate monomer, a methacrylate monomer, vinyl acetate, acrylonitrile, acrylamide, acrylic acid, or any combination thereof. In some embodiments, for example, selectively removing discrete portions of the graft monomer layer may comprise photolithography. In further embodiments, for instance, grafting the plurality of graft polymers to the substrate may comprise ultraviolet (UV) initiated grafting.

In accordance with certain embodiments, for example, the method may further comprise grafting a biocidal agent to the substrate. In some embodiments, for instance, the biocidal agent may comprise a quaternary ammonium salt.

Modifications of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of forming a directed bioadhesion coating, the method comprising:
providing a substrate having a graft monomer layer on a surface thereof;
selectively removing discrete portions of the graft monomer layer to expose the substrate surface;
polymerizing any remaining portions of the graft monomer layer via reversible addition-fragmentation chain-transfer (RAFT) polymerization with a RAFT chain transfer agent to form a plurality of graft polymers; and
simultaneously with polymerizing the remaining graft monomer layer, grafting the plurality of graft polymers to the substrate to form a chemical pattern on the substrate.

2. The method of claim 1, wherein providing the substrate having the graft monomer layer on the surface thereof comprises:
providing the substrate; and
providing the graft monomer layer on the substrate.

3. The method of claim 1, wherein providing the substrate comprises providing at least one of a polypropylene, a polyethylene, polyethylene terephthalate, a silicone rubber, polyvinyl chloride, a polyamide, or any combination thereof.

4. The method of claim 1, wherein the graft monomer layer comprises a layer of at least one of an acrylate monomer, a methacrylate monomer, vinyl acetate, acrylonitrile, acrylamide, acrylic acid, or any combination thereof.

5. The method of claim 1, wherein selectively removing discrete portions of the graft monomer layer comprises photolithography.

6. The method of claim 1, wherein grafting the plurality of graft polymers to the substrate comprises ultraviolet (UV) initiated grafting.

7. The method of claim 1, further comprising grafting a biocidal agent to the substrate.

8. The method of claim 7, wherein the biocidal agent comprises a quaternary ammonium salt.

9. A directed bioadhesion coating comprising:
a substrate; and
a plurality of graft polymers grafted on the substrate,
wherein the plurality of graft polymers define a chemical pattern on the substrate.

10. The directed bioadhesion coating of claim 9, wherein the directed bioadhesion coating is formed by a method comprising:
providing the substrate having a graft monomer layer on a surface thereof;
selectively removing discrete portions of the graft monomer layer to expose the substrate surface;
polymerizing any remaining portions of the graft monomer layer via reversible addition-fragmentation chain-transfer (RAFT) polymerization with a RAFT chain transfer agent to form the plurality of graft polymers; and
simultaneously with polymerizing the remaining graft monomer layer, grafting the plurality of graft polymers to the substrate to form the chemical pattern on the substrate.

11. The directed bioadhesion coating of claim 10, wherein providing the substrate having the graft monomer layer on the surface thereof comprises:
providing the substrate; and
providing the graft monomer layer on the substrate.

12. The directed bioadhesion coating of claim 9, wherein the substrate comprises at least one of a polypropylene, a polyethylene, polyethylene terephthalate, a silicone rubber, polyvinyl chloride, a polyamide, or any combination thereof.

13. The directed bioadhesion coating of claim 10, wherein the graft monomer layer comprises a plurality of at least one of an acrylate monomer, a methacrylate monomer, vinyl acetate, acrylonitrile, acrylamide, acrylic acid, or any combination thereof.

14. The directed bioadhesion coating of claim 10, wherein selectively removing discrete portions of the graft monomer layer comprises photolithography.

15. The directed bioadhesion coating of claim 9, wherein the plurality of graft polymers are grafted onto the substrate via ultraviolet (UV) initiated grafting.

16. The directed bioadhesion coating of claim 9, further comprising a biocidal agent grafted to the substrate.

17. The directed bioadhesion coating of claim 16, wherein the biocidal agent comprises a quaternary ammonium salt.

18. A method of directing bioadhesion on a base surface, the method comprising providing a directed bioadhesion coating on the base surface, wherein the directed bioadhesion coating comprises:
a substrate; and
a plurality of graft polymers grafted on the substrate,
wherein the plurality of graft polymers define a chemical pattern on the substrate.

19. The method of claim 18, wherein the directed bioadhesion coating is formed by a method comprising:
providing the substrate having a graft monomer layer on a surface thereof;
selectively removing discrete portions of the graft monomer layer to expose the substrate surface;
polymerizing any remaining portions of the graft monomer layer via reversible addition-fragmentation chain-transfer (RAFT) polymerization with a RAFT chain transfer agent to form the plurality of graft polymers; and
simultaneously with polymerizing the remaining graft monomer layer, grafting the plurality of graft polymers to the substrate to form the chemical pattern on the substrate.

20. The method of claim 19, wherein providing the substrate having the graft monomer layer on the surface thereof comprises:
providing the substrate; and
providing the graft monomer layer on the substrate.

21. The method of claim 18, wherein the substrate comprises at least one of a polypropylene, a polyethylene, polyethylene terephthalate, a silicone rubber, polyvinyl chloride, a polyamide, or any combination thereof.

22. The method of claim 18, wherein the graft monomer layer comprises a layer of at least one of an acrylate monomer, a methacrylate monomer, vinyl acetate, acrylonitrile, acrylamide, acrylic acid, or any combination thereof.

23. The method of claim 19, wherein selectively removing discrete portions of the graft monomer layer comprises photolithography.

24. The method of claim 19, wherein grafting the plurality of graft polymers to the substrate comprises ultraviolet (UV) initiated grafting.

25. The method of claim 19, further comprising grafting a biocidal agent to the substrate.

26. The method of claim 25, wherein the biocidal agent comprises a quaternary ammonium salt.
